(19) United States
(12) Patent Application Publication
(10) Pub. No.: US 2006/0064530 A1
(43) Pub. Date: Mar. 23, 2006

(54) Integrated PCI interface card

(76) Inventors: Ching-Chung Lai, Taipei (TW); Jung-Tsan Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/126,196

(22) Filed: May 11, 2005

(30) Foreign Application Priority Data
Sep. 17, 2004 (TW) 093128309

(51) Int. Cl. G06F 13/00

(52) U.S. Cl. 710/300

(57) ABSTRACT

Disclosed is an integrated PCI interface card, comprising a multi-functional IC chip, a first set of signal lines, a mono-functional IC chip, and a second set of signal lines. The multi-functional IC chip includes a plurality of functional circuits and an arbiter, and each of the first set of signal lines and the second set of signal lines includes the signal lines required in the PCI bus transactions. The first set of signal lines is arranged to couple the multi-functional IC chip to a PCI bus, and a request signal line, a grant signal line, and an initialization device select signal line of the second set of signal lines are arranged to couple the multi-functional IC chip and the mono-functional IC chip, while the other signal lines of the second set of signal lines are arranged to couple the mono-functional IC chip to the PCI bus.

### FIELD OF THE INVENTION

The present invention is related to a PCI interface card, and more particularly to an integrated PCI interface card, coupling a request signal line, a grant signal line, and an initialization device select signal line of a mono-functional IC chip to a multi-functional IC chip, an arbiter located within the multi-functional IC chip for arbitration, and thereby incorporate various IC chips in a single PCI interface card and reduce the manufacturing cost.

### BACKGROUND OF THE INVENTION

With the rapid development in information technology, the upgrade of an information-processing electronic product has been incessantly progressing. Most of the users would give more attention to an electronic product with a high versatility. Therefore, a majority of electronic product vendors tend to vest a single electronic product with a variety of functionalities in order to strive for more business opportunities.

A typical representation of a conventional PCI interface is depicted in FIG. 1. The PCI interface of FIG. 1 includes a PCI interface card 12 with a plurality of IC chips mounted thereon and a bridger 125 coupled to a PCI bus 10. The IC chips located within the PCI interface card 12, for example, a first IC chip 121 and a second IC chip 123, are coupled to the bridger 125 via a first bus 14 and a second bus 16, respectively, where the first bus 14 and the second bus 16 both comprise the same signal lines that are used to communicate with the PCI bus 10, for example, initialization device select (IDSEL) signal lines (IDSEL1 signal line 141 and IDSEL2 signal line 161), request (REQ) signal lines (REQ1 signal line 143 and REQ2 signal line 163), grant (GNT) signal lines (GNT1 signal line 145 and GNT2 signal line 165), and other signal lines, for example, address/data (A/D) bus and various interface signal lines.

The bus arbitration process of the PCI bus 10 is described as follows. When the first IC chip 121 is desired to use the PCI bus 10, a request signal is sent from the first IC chip 121 to the bridger 125 via the REQ1 signal line 143. The arbiter (not shown) located within the bridger 125 then determines whether to grant the mastership of the PCI bus 10 to the first IC chip 121. If it is determined that the first IC chip 121 is granted with the mastership of the PCI bus 10, a grant signal is sent from the bridger 125 to the first IC chip 121, and the first IC chip 121 obtains the rights to use the PCI bus 10 accordingly.

When the PCI subsystem is desired to access the first IC chip 121, an access signal is sent from the bridger 125 to the first IC chip 121 via IDSEL1 signal line 141. Next, the access cycle operation to the first IC chip 121 is carried out by the address/data signal lines and other interface signal lines (not shown for simplicity) . When the second IC chip 123 is desired to use the PCI bus 10 or the PCI subsystem is desired to access the second IC chip 123, the bus arbitration operations can be performed in a way which is similar to what was described above.

With the techniques discussed above, the purpose of incorporating a plurality of IC chips into a single PCI interface card can be fulfilled. However, there allows two IC chips performing different functions to be integrated into a single PCI interface card according to the state-of-the-art level in the industry, and thus there needs a bridger to be mounted in the PCI interface card. This would provide a limited versatility to the PCI interface card, and would result in a relatively high manufacturing cost for the PCI interface card.

### SUMMARY OF THE INVENTION

In view of the deficiencies encountered by the prior art, a primary object of the present invention is accomplished by the provision of an integrated PCI interface card which combines the advantages of a mono-functional IC chip and the advantages of a multi-functional IC chip into a single PCI device.

A secondary object of the present invention is to provide an integrated PCI interface card in which the configuration and the allocation of the bus arbiter is modified and the number of arbitration nodes of the bus arbiter is increased, and thereby the bus arbitration process can be accomplished smoothly as multiple functional IC chips are incorporated into the PCI interface card.

Another object of the present invention is to provide an integrated PCI interface card in which additional pins are mounted on a multi-functional IC chip for coupling to a mono-functional IC chip, and thus the cost associated with the bridger is curtailed.

To attain the above and other objects, the present invention provides an integrated PCI interface card, which comprises a multi-functional IC chip including a plurality of functional circuits and an arbiter; a first set of signal lines including a plurality of signal lines used to communicate over a PCI interface for coupling the multi-functional IC chip to a PCI bus; a mono-functional IC chip; and a second set of signal lines including a request signal line, a grant signal line, a initialization device select signal line, and other signal lines required in the bus transactions over the PCI interface, wherein the request signal line, the grant signal line and the initialization device select signal line of the second set of signal lines couple the mono-functional IC chip to the multi-functional IC chip, and the other signal lines of the second set of signal lines couple the mono-functional IC chip to the PCI bus, so that an integrated PCI interface card incorporating a variety of functional IC chips is implemented with a lower manufacturing cost.

Another aspect of the present invention includes an integrated PCI interface card, which comprises a first mono-functional IC chip including a functional circuit and an arbiter; a first set of signal lines including a plurality of signal lines used to communicate over a PCI interface for coupling the first mono-functional IC chip to a PCI bus; a second mono-functional IC chip; and a second set of signal lines including a request signal line, a grant signal line, a initialization device select signal line, and other signal lines required in the bus transactions over the PCI interface, wherein the request signal line, the grant signal line and the initialization device select signal line of the second set of signal lines couple the first mono-functional IC chip to the second mono-functional IC chip, and the other signal lines of the second set of signal lines couple the first mono-functional IC chip to the PCI bus, so that an integrated PCI interface card incorporating various functional IC chips is implemented with a lower manufacturing cost.

The foregoing and features and advantages of the present invention will become more apparent through the following descriptions with reference to the accompanying drawings, in which:

### BRIEF DESCRIPTION OF THE DRAWINGS

FIG. 1 shows a typical representation of a conventional PCI interface;

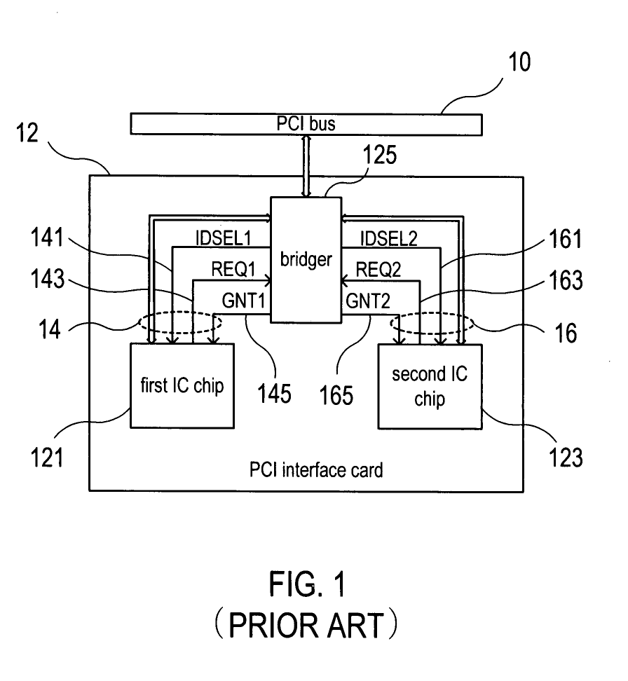

FIG. 2 shows a typical representation of PCI interface according to an embodiment of the present invention; and

FIG. 3 shows a typical representation of PCI interface according to an additional embodiment of the present invention.

### DETAILED DESCRIPTION OF THE PREFERRED EMBODIMENT

The present invention will now be described in detail in accordance with the following descriptions in conjunction with drawings. The present invention can be well known and be accomplished by anyone skilled in the related art in light of the following embodiments, but it is to be understood that the exact implementation of the present invention can not be limited by the disclosed embodiments.

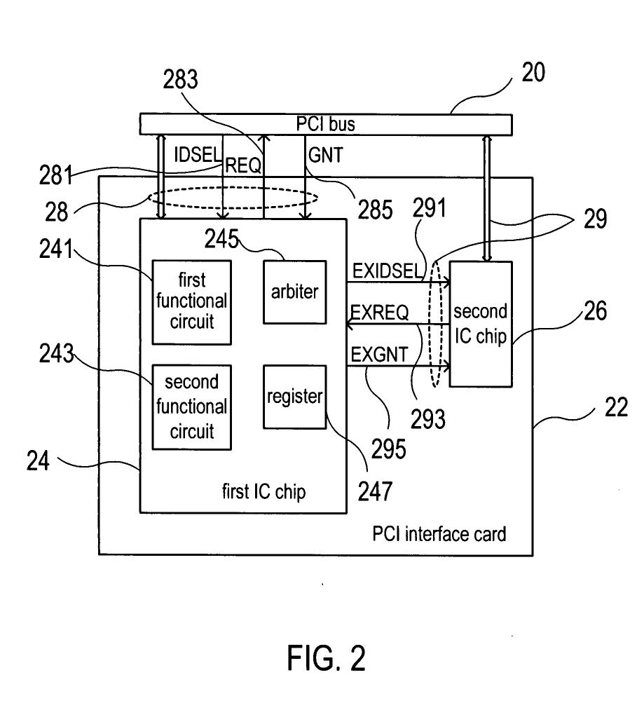

FIG. 2 is a schematic circuit block diagram according to an embodiment of the present invention. The PCI interface card 22 of the present invention includes principally a first IC chip 24 and a second IC chip 26, in which the first IC chip 24 is a multi-functional IC chip including an arbiter 245, a register 247, and a plurality of functional circuits. An exemplary example of the number of the functional circuits within the first IC chip 24 is designated as 2 in the present embodiment, i.e. a first functional circuit 241 and a second functional circuit 242 are located within the first IC chip 24, and the arbiter 245 should be designed as a 3-to-1 arbiter, wherein the number of arbitration nodes of the arbiter 245 should be greater than the number of the functional circuits within the first IC chip 24 by one. The first IC chip 24 is coupled to the PCI bus 20 by a first set of signal lines 28, which includes an initialization device select (IDSEL) signal line 281, a request (REQ) signal line 283, a grant (GNT) signal line 285 and other signal lines, for example, address/data (A/D) bus and various interface signal lines.

The second IC chip 26 is a mono-functional IC chip which is coupled to the PCI bus 20 and the first IC chip 24 by a second set of signal lines 29. Similarly, the second set of signal lines 29 includes an initialization device select (EXIDSEL) signal line 291, a request (EXREQ) signal line 293, a grant (EXGNT) signal line 295 and other signal lines, for example, address/data (A/D) bus and various interface signal lines. The EXIDSEL signal line 291, the EXREQ signal line 293, and the EXGNT signal line 295 are coupled to three additional pins mounted on the first IC chip, while other signal lines are coupled to the PCI bus 20.

The register 247 of the first IC chip 24 is originally programmed to maintain a record identifying the first IC chip itself as a multi-functional IC chip. Therefore, the record can be retrieved from the register 247 during system initialization, and then each functional circuit mounted on the PCI interface card 22 can be scanned one by one. When it is desired to access the first functional circuit 241 or the second functional circuit 243 of the first IC chip 24 via the PCI bus 20, a notification signal is sent to the first IC chip 24 via the IDSEL signal line 281 and a function number signal is sent to the first IC chip 24 via the eighth to tenth bit lines of address/data bus (AD[10:8]). The arbiter 245 directs the access operation initiated by the PCI bus 20 to the first functional circuit 241 when the function number is zero or to the second functional circuit 243 when the function number is one according to the decoded function number. When each functional circuit is desired to conduct data communications with the PCI subsystem via the PCI bus 20, a request signal is sent to the arbiter 245. The arbiter 245 then sends a request signal to the PCI subsystem via the REQ signal line 283 according to its arbitration priority. The PCI subsystem responds to the request signal from the arbiter 245 with a grant signal to be transmitted via the GNT signal line 285. The grant signal is sent to the corresponding functional circuit to allow the mastership of the PCI bus 20 for the corresponding functional circuit to use the PCI bus 20.

When the PCI subsystem is desired to access the second IC chip 26, a notification signal is sent to the first IC chip 24 via the IDSEL signal line 281, and a function number signal designating a function number of 2 is sent to the first IC chip 24. Next, the arbiter 245 forwards the notification signal to the second IC chip 26 via the EXIDSEL signal line 291, and the second IC chip 26 is enabled accordingly. In this manner, the PCI subsystem can complete the access operation to the second IC chip 26 via the second set of signal lines 29. When the second IC chip 26 is desired to conduct data communication with the PCI subsystem via the PCI bus 20, a request signal is sent to the arbiter 245 of the first IC chip 24 via the EXREQ signal line 293. The arbiter 245 then sends a request signal to the PCI subsystem via the REQ signal line 283 according to its arbitration priority. The PCI subsystem responds to the request signal from the arbiter 245 with a grant signal to be transmitted via the GNT signal line 285. The grant signal is sent to the second IC chip 26 to allow the mastership of the PCI bus 20 for the second IC chip 26 to use the PCI bus 20.

By way of the principle as stated above, the circuit design of the PCI interface card 22 can be configured to incorporate a plurality of mono-functional IC chips by coupling the initialization device select signal line, the request signal line and the grant signal line of each mono-functional IC chip to the first IC chip 24 and modifying the number of arbitration nodes of the arbiter 245 within the first IC chip 24. In this way, the PCI interface card incorporating a plurality of mono-functional IC chips and is operating smoothly and accurately can be obtained.

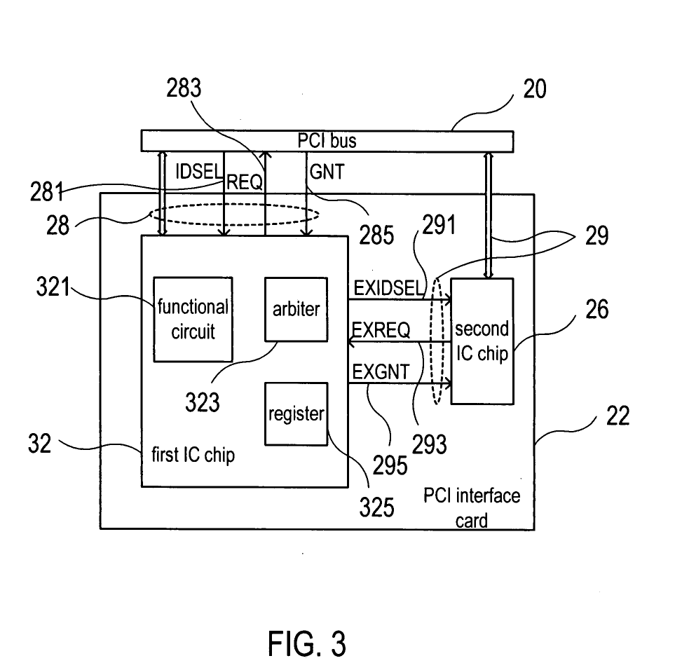

Referring to FIG. 3, which shows the circuit block diagram according to an additional embodiment of the present invention. As shown in FIG. 3, the circuit architecture of the embodiment of FIG. 3 is similar to the embodiment of FIG. 2. However, the first IC chip 32 in FIG. 3 is a mono-functional IC chip, and therefore it contains a single functional circuit 321. To provide the functionality of bus arbitration in response to the incorporation of the second IC chip 26, an arbiter 323 is mounted within the first IC chip 32 to perform a 2-to-1 bus arbitration process, and the records maintained in the register 325 of the first IC chip 32 should be modified to identify the first IC chip 32 as a multi-functional IC chip.

In the light of the configuration disclosed by the additional embodiment of the present invention, the records maintained in the register 325 are retrieved therefrom and the PCI interface card 22 is identified as a multi-functional interface card accordingly. Further, the functional circuits mounted on the PCI interface card 22 will be scanned one by one. When the PCI subsystem is desired to access the functional circuit 321 of the first IC chip 32, a notification signal is sent to the first IC chip 32 via the IDSEL signal line 281, and a function number signal designating a function number of 0 is sent to the first IC chip via the address/data bus. The arbiter 323 then directs the access operation initiated by the PCI bus 20 to the functional circuit 321. When the first IC chip 32 is desired to conduct data communication with the PCI subsystem via the PCI bus 20, a request signal is sent from the functional circuit 321 to the arbiter 323. Next, the arbiter 323 sends a request signal to the PCI subsystem via the REQ signal line 283 according to its arbitration priority. The PCI subsystem responds to the request signal from the arbiter 323 with a grant signal to be transmitted via the GNT signal line 285. The grant signal is sent to the functional circuit 321 to allow the mastership of the PCI bus 20 for the functional circuit 321 to use the PCI bus 20.

When the PCI subsystem is desired to access the second IC chip 26, a notification signal is sent to first IC chip 32 via the IDSEL signal line and a function number signal designating a function number of 1 is sent to the first IC chip 32. Next, the arbiter 323 forwards the notification signal to the second IC chip 26 via the EXIDSEL signal line 291, and the second IC chip 26 is enabled accordingly. In this manner, the PCI subsystem can complete the access operation to the second IC chip 26 via the second set of signal lines 29. When the second IC chip 26 is desired to conduct data communication with the PCI subsystem via the PCI bus 20, a request signal is sent to the arbiter 323 of the first IC chip 32 via the EXREQ signal line 293. The arbiter 323 then sends a request signal to the PCI subsystem via the REQ signal line 283 according to its arbitration priority. The PCI subsystem responds to the request signal from the arbiter 323 with a grant signal to be transmitted via the GNT signal line 285. The grant signal is sent to the second IC chip 26 to allow the mastership of the PCI bus 20 for the second IC chip 26 to use the PCI bus 20.

The principle of the present invention can also be applied to achieve other implementations that incorporate multiple mono-functional circuits into a single PCI device. To this end, in an alternative embodiment of the present invention the initialization device select signal line, the request signal line, and the grant signal line of each mono-functional IC chip are coupled to the first IC chip 32, and the number of the arbitration nodes of an arbiter is modified to ensure the regular operation of the PCI interface card incorporating a variety of mono-functional IC chips.

Likewise, with the configuration of PCI interface card disclosed heretofore, the requirement of incorporating a variety of functional IC chips into a single PCI device can be filled by a simple alteration to the circuit design of the functional chips. Hence, the manufacturing cost of PCI interface card can be reduced dramatically. More advantageously, the second IC chip 26 and other mono-functional IC chips do not need to possess the functionality of decoding the function number codes, and thereby the probability of errors incurred during the decoding process of the function number signal is lowered.

In conclusion, the inventive integrated PCI interface card is implemented by coupling the request signal line, the grant signal line, and the initialization device select signal line of a mono-functional IC chip to a multi-functional IC chip. In this way, the bus arbitration process is performed by the arbiter embedded in the multi-functional IC chip, so that the PCI interface card is capable of incorporating a variety of functional IC chips and reducing its manufacturing cost significantly.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. An integrated PCI card, comprising:
a multi-functional IC chip including a plurality of functional circuits and an arbiter;
a first set of signal lines including a plurality of signal lines used to communicate over a PCI interface for coupling the multi-functional IC chip to a PCI bus;
a mono-functional IC chip; and
a second set of signal lines including a request signal line, a grant signal line, an initialization device select signal line, and signal lines required in bus transactions over the PCI interface;
wherein the request signal line, the grant signal line and the initialization device select signal line of the second set of signal lines couple the mono-functional IC chip and the multi-functional IC chip, while the other signal lines of the second set of signal lines couple the mono-functional IC chip to the PCI bus.

2. The integrated PCI card according to claim 1, wherein the number of arbitration nodes of the multi-functional IC chip is greater than the number of functionalities provided by the multi-functional IC chip.

3. The integrated PCI card according to claim 1, wherein the mono-functional IC chip is not provided with the functionality of decoding function number codes.

4. The integrated PCI card according to claim 1, wherein the integrated PCI card is allowed to incorporate at least one mono-functional IC chip.

5. The integrated PCI card according to claim 1, wherein the number of devices for which the arbiter arbitrates therebetween is equal to the number of the functional circuits of the multi-functional IC chip plus the number of mono-functional IC chip.

6. An integrated PCI card, comprising:
a first mono-functional IC chip including a functional circuit and an arbiter;
a first set of signal lines including a plurality of signal lines used to communicate over a PCI interface for coupling the first mono-functional IC chip to a PCI bus;
a second mono-functional IC chip; and
a second set of signal lines including a request signal line, a grant signal line, an initialization device select signal line, and signal lines required in bus transactions over the PCI interface;
wherein the request signal line, the grant signal line and the initialization device select signal line of the second set of signal lines couple the second mono-functional IC chip and the first mono-functional IC chip, while the other signal lines of the second set of signal lines couple the second mono-functional IC chip to the PCI bus.

7. The integrated PCI card according to claim 6, wherein the arbiter is a 2-to-1 arbiter.

8. The integrated PCI card according to claim 6, wherein the second mono-functional IC chip is not provided with the functionality of decoding function number codes.

9. The integrated PCI card according to claim 6, wherein the first mono-functional IC chip further includes a register maintaining a record identifying the first mono-functional IC chip as a multi-functional IC chip.

10. The integrated PCI card according to claim 6, wherein the integrated PCI card further includes at least one mono-functional IC chip.

11. The integrated PCI card according to claim 10, wherein the number of devices for which the arbiter arbitrates therebetween is equal to the number of the functional IC chips of the integrated PCI card.
